(19) United States
(12) Patent Application Publication
(10) Pub. No.: US 2024/0207657 A1
(43) Pub. Date: Jun. 27, 2024

(54) FACE MASK DEVICE ALLOWING COMFORTABLE RESPIRATION ACCORDING TO AIR FLOW

(71) Applicant: Je Hoon KIM, Seoul (KR)

(72) Inventor: Je Hoon KIM, Seoul (KR)

(21) Appl. No.: 18/289,101

(22) PCT Filed: Aug. 22, 2022
(86) PCT No.: PCT/KR2022/012546

§ 371 Date: Oct. 31, 2023

(30) Foreign Application Priority Data
Aug. 24, 2021 (KR) 10-2021-0111729

(51) Int. Cl. A62B 7/10; A62B 7/12; A62B 18/00; A62B 18/02

(52) U.S. Cl. CPC A62B 7/10; A62B 7/12; A62B 18/006; A62B 18/025

(57) ABSTRACT

A facial mask device 1000 according to the present invention has a mask body 500 worn in close contact with the user's face and a space S is formed between inside of the mask body 500 and the user's face for storing air for the user's respiration. The mask body 500 has an inlet part 530 having an inlet 538 through which the purified air supplied by the purified air supply means is supplied into the space S and an outlet part 360 having an outlet 364 through which the purified air supplied into the space S is discharged.

### FIELD OF THE INVENTION

The present invention relates to a facial mask device, and more specifically, to a facial mask device that allows comfortable breathing as a wearer can breathe along the air flow.

### BACKGROUND OF THE INVENTION

A facial mask is a device that covers the wearer's respiratory system by fitting tightly on the face and protects the wearer's respiratory system from external contaminants. A typical facial mask is made of fabric-like filters that purify the air according to a certain criterion. However, this may cause the wearer to feel stuffy, as not enough air gets in when inhaling, and carbon dioxide and moisture are not released well when exhaling.

To solve these problems, there are attempts to achieve comfortable breathing by forcibly introducing outside air into the mask using a blower or a fan.

The mask device of Korean Patent laid-open Publication No. 10-2020-0080110 and the mask device and its control method of Korean Registered Patent No. 10-2256713 are examples of such efforts.

In relation to the facial mask device that introduces outside air into the inside of the mask using a blower or a fan, there are the following requests.

First, it should be able to achieve comfortable breathing and sufficient carbon dioxide release with a simple structure.

Second, users should be able to have conversations or use phones/headset while wearing the facial mask device.

Third, the weight of the mask body that is worn on the face should be reduced to make it comfortable to wear.

Fourth, there are cases where the source of contamination is mainly in front of the mask wearer, such as when cooking, and in such cases, the inflow of contaminants from the source of contamination should be minimized.

The present invention was devised to fulfill these requests.

### DETAILED DESCRIPTION OF THE INVENTION

### The Problem to be Solved

The object of the present invention is to provide a facial mask device that satisfies the aforementioned requests. That is, the present invention provides a facial mask device that can achieve comfortable breathing and sufficient carbon dioxide release with a simple structure, can have conversations or phone calls while wearing it, reduces the weight of the mask body that is worn on the face to make it comfortable to wear, and also minimizes the inflow of contaminants from the source of contamination.

### Technical Solution

The present invention provides a facial mask comprising:
(a) a mask body worn in close contact with the user's face to cover the user's face having a left cheek part, a right cheek part and a front part therebetween; wherein a space is formed between the inside of the mask body and the user's face for storing air for the user's respiration,
(b) a purified air supply means for supplying purified air to the space of the mask body; wherein
(c1) the mask body includes an inlet part having an inlet through which the purified air supplied by the purified air supply means is supplied into the space and an outlet part having an outlet through which the purified air supplied into the space is discharged,
(c2) when the user wears the mask body and the purified air supply means operates, the purified air flow from the inlet of the inlet part to the outlet of the outlet part forms a forced flow by pressure supplied by the purified air supply means into the space,
(c3) when the user wears the mask body, the user's respiratory system is positioned in the middle of the forced flow between the inlet of the inlet part and the outlet of the outlet part,
(c4) so that when the user wears the mask body and the purified air supply means operates, the forced flowing air is inhaled when the user inhales and the exhaled breath is discharged when the user exhales along the forced flow.

According to the present invention, it is preferable that the space of the mask body has a volume that can store an amount of air that the wearer breathe in one breath.

According to the present invention, it is preferable that the inlet of the inlet part forms a flow field in the direction crossing the user's face, and the air supplied to the space through the inlet flows along the transverse direction crossing the user's face. According to the present invention, it is preferable that the outlet of the outlet part is
(a) positioned at a place that crosses over the user's respiratory system along the direction that crosses the user's face when the user wears the mask body, and,
(b) positioned at a distance that prevents external air from being sucked in by the suction force of the user's breathing when the user inhales.

According to the present invention, it is preferable that the outlet of the outlet part is positioned between the user's cheek and a side of the mask body.

According to the present invention, it is preferable that the outlet of the outlet part is formed vertically or at an acute angle to the vertical toward the rear direction of the mask body with respect to the direction that crosses the face of the user wearing the mask body.

According to the present invention, it is preferable that an air purification filter is installed with respect to the outlet in the outlet part, especially detachably installed with respect to the outlet in the outlet part.

According to the present invention, it is preferable that the inlet part has an air distribution means for distributing air flowing in from the purified air supply means and introducing it into the space.

According to the present invention, it is preferable that the purified air supply means is provided outside of the mask body and rested on the user's neck.

According to the present invention, it is preferable that the purified air supply means includes an air purification filter and a blowing part that draws air from outside through the air purification filter and blows the air to the space of the mask body. The present invention also provides a facial mask device comprising:
(a) a mask body covering a user's face; wherein a space is formed between inside of the mask body and the user's face for storing air for the user's respiration,
(b) a purified air supply means for supplying purified air to the space; wherein,
(c1) the mask body includes an inlet part having an inlet through which the purified air supplied by the purified air supply means is supplied into the space and an outlet part having an outlet through which the purified air supplied into the space is discharged,
(c2) purified air supply means is provide outside of the mask body and is rested on the user's neck.

Further, the present invention provides a mask body covering a user's face worn in close contact with the user's face wherein
(a) when the user wears the mask body, a space is formed between inside of the mask body and the user's face for storing air for the user's respiration,
(b) the user wears the mask body and purified air is supplied to the space by a purified air supply means,
(c) the mask body includes an inlet part having an inlet through which the purified air supplied by the purified air supply means is supplied into the space and an outlet part having an outlet through which the purified air supplied into the space is discharged,
(d) when the user wears the mask body and the purified air supply means operates, the purified air flow from the inlet of the inlet part to the outlet of the outlet part forms a forced flow by pressure supplied by the purified air supply means into the space,
(e) when the user wears the mask body, the user's respiratory system is positioned in the middle of the forced flow between the inlet of the inlet part and the outlet of the outlet part,
(f) the outlet of the outlet part is positioned at a place that crosses over the user's respiratory system along the direction that crosses the user's face when the user wears the mask body and at a distance that prevents external air from being sucked in by the suction force of the user's breathing when the user inhales,
(g) so that when the user wears the mask body and the purified air supply means operates, the forced flowing air is inhaled when the user inhales and the exhaled breath is discharged when the user exhales along the forced flow.

According to the present invention, it is preferable that the space of the mask body has a volume that can store an amount of air that the wearer breathe in one breath.

### Effects of the Invention

The present invention offers the following distinctive advantages.

First, it becomes possible to achieve comfortable breathing and sufficient carbon dioxide release with a simple structure.

This is because there is a forced air flow from the inlet of the mask body to the outlet and the user's respiratory system is located in the middle of the forced air flow so that when the user inhales, the forced air flow is inhaled, and when the user exhales, the exhaled breath is expelled along the forced air flow.

This means that breathing of inhales and exhales becomes easier with the help of the forced air flow, and especially, the carbon dioxide contained in the exhaled breath can be immediately expelled, making it possible to breathe more comfortably.

Second, the facial mask device according to the present invention allows the wearer to converse or communicate using phones.

This implies that, in accordance with the present invention, the facial mask device has an open outlet for the user's breath, enabling the wearer to converse or communicate using phones. This benefit may be diminished if an air purification filter is attached to the outlet.

Third, the facial mask body worn on the face according to the present invention is lightweight and comfortable to wear, and also, the present invention can effectively prevent the inflow of contaminants from sources that are often in front of the mask wearer, such as cooking.

This is because the mask body is separated from a purified air supply means, that is located around the user's neck as an example.

### BRIEF DESCRIPTION OF THE DRAWINGS

FIGS. 1 to 3 are views showing the overall structure of a facial mask device 1000 according to an embodiment of the present invention;

FIGS. 4 to 7 are views showing the structure of a mask body 500 of the facial mask device 1000 according to the embodiment of the present invention;

FIG. 8 is a view showing an example of the facial mask device 1000 worn by a user;

FIG. 9 is a view showing another embodiment of the present invention, in which an outlet is formed on the upper surface of the mask body.

### DETAILED DESCRIPTION

Now, preferred embodiments of the present invention will be described in detail with reference to the accompanying drawings.

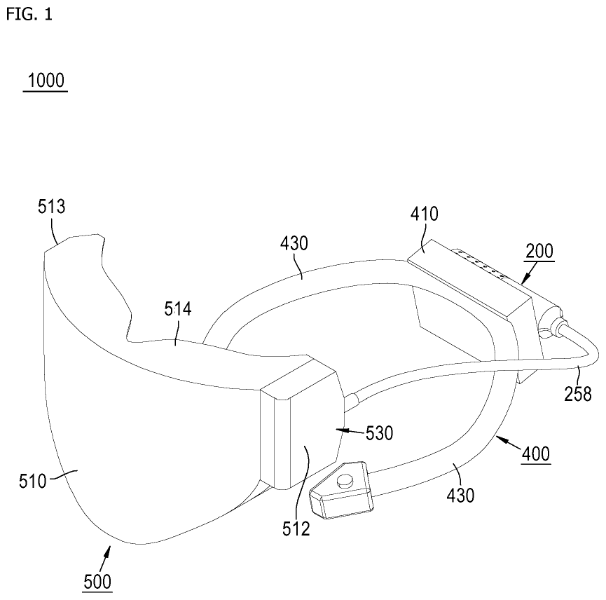

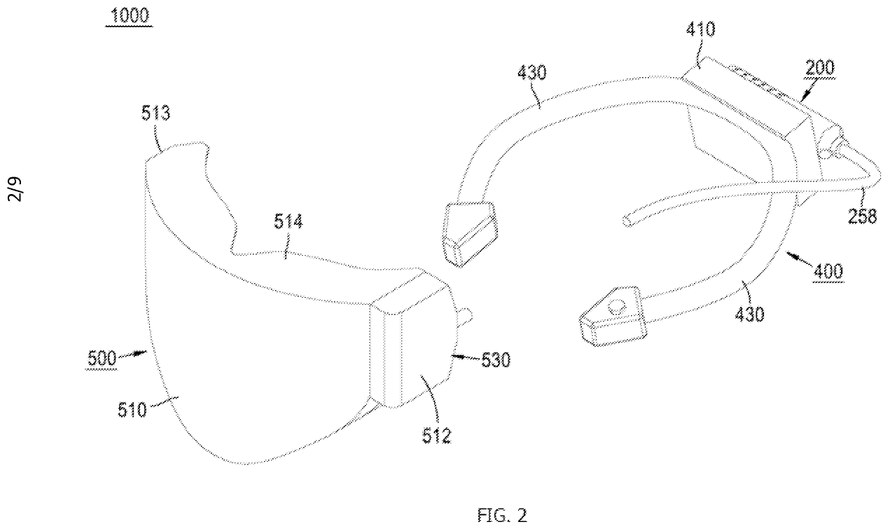

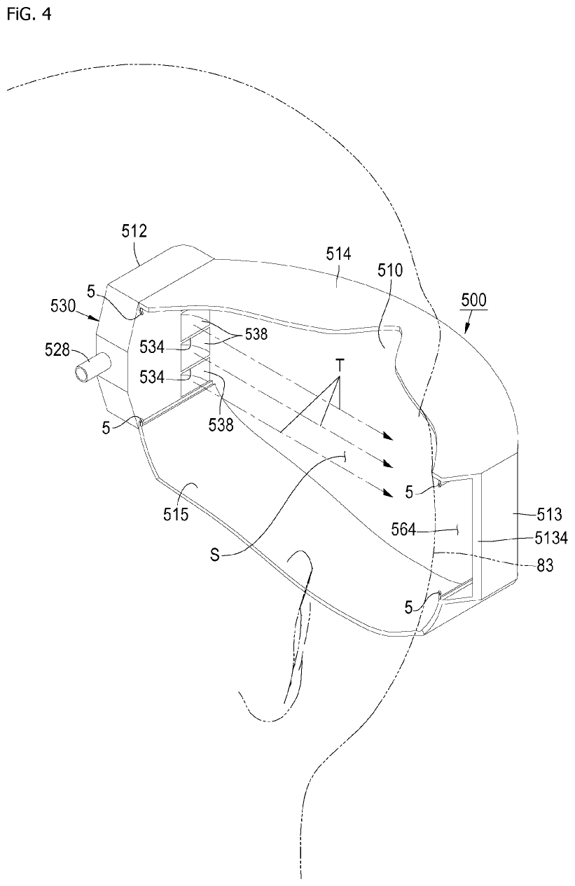

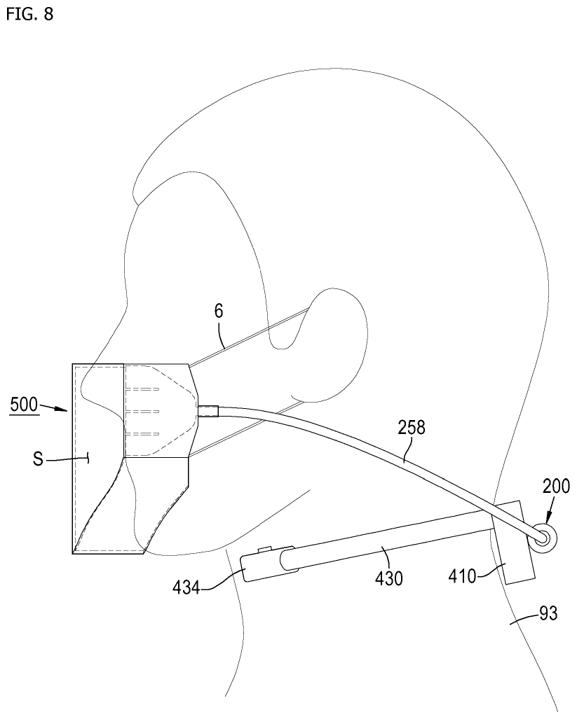

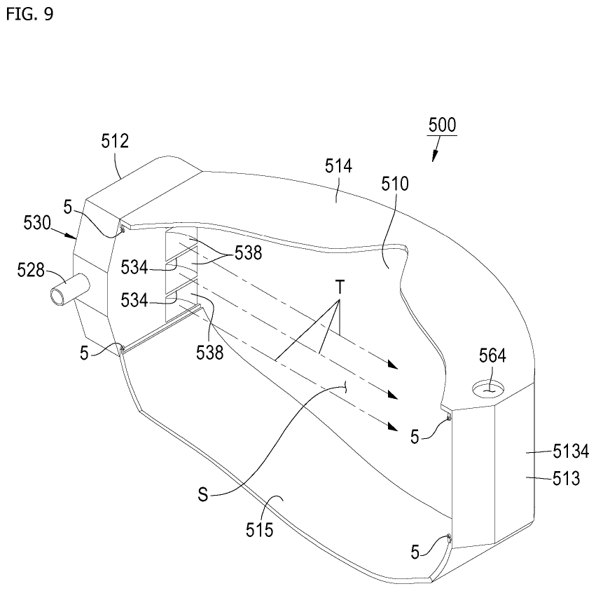

FIGS. 1 to 3 are views showing the overall structure of a facial mask device 1000 according to an embodiment of the present invention, FIGS. 4 to 7 are views showing the structure of a mask body 500 of the facial mask device 1000 according to the embodiment of the present invention, FIG. 8 is a view showing an example of the facial mask device 1000 worn by a user, and FIG. 9 is a view showing another embodiment of the present invention, in which an outlet is formed on the upper surface of the mask body.

Referring to these drawings, the facial mask device 1000 according to the present invention has a mask body 500 and a purified air supply means 200 that supplies purified air to the mask body 500.

The mask body 500 is a part that is worn on the user's face and covers the user's face to protect the user's respiratory system (nose and mouth).

According to the present invention, the mask body 500 has a left cheek part 512, a right cheek part 513 and a front part 510 between them.

The front part 510, the left cheek part 512 and the right cheek part 513 respectively refer to the parts where the user's front, left cheek and right cheek are respectively located when the user wears the mask body 500.

In this embodiment, an inlet part 530 through which purified air supplied from a purified air supply means 200 flows in, is provided in the left cheek part 512 where the user's left cheek is located.

Also, an outlet part 560 through which the air that has flowed into the mask body 500 is discharged, is provided in the right cheek part 513 where the user's right cheek is located, and as will be described later, the outlet 564 thereof is formed between the user's right cheek 83 and the right side 5134 of the mask body 500. (See FIG. 4) In this embodiment, also, an upper surface part 514 and a lower surface part 515 are formed by extending inwardly from each of the upper edge and the lower edge of the front part 510.

The mask body 500 is worn in close contact with the user's face, and it is desirable that it is made of a material that is well bendable and has excellent adhesion to the user's face.

On the other hand, for the mask body 500, additional sealing can be implemented with a material such as silicone to enhance the adhesion.

According to the present invention, the front part 510, the left cheek part 512 and the right cheek part 513 of the mask body 500 may have unclear boundaries between them.

For example, the mask body 500 may have a streamlined shape along the transverse direction, and in this case, their boundaries may not be clearly distinguished. Also, the mask body (500) may have a streamlined shape along the vertical direction, and in this case, the upper surface part (514) and the lower surface part 515 may not be distinguished from the front surface part 510 and they may be recognized as one body.

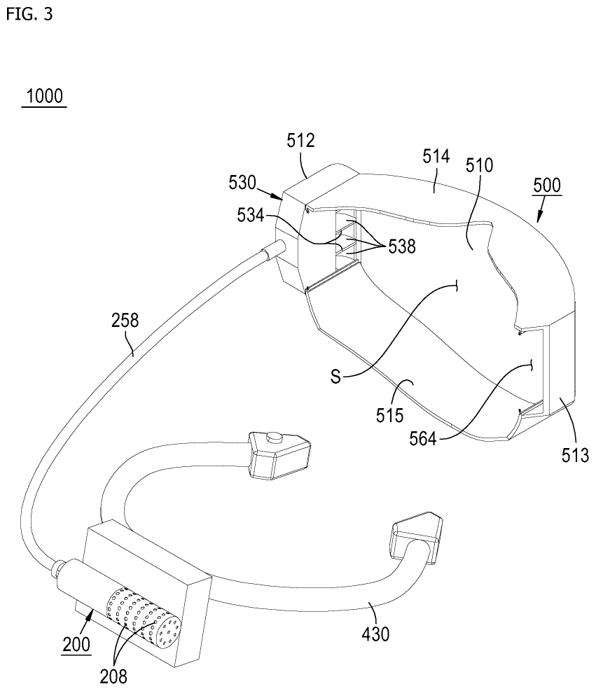

According to the present invention, a space S is formed between the inside of the mask body 500 and the user's face, and air for the user's respiration is stored therein. That is, as shown in FIG. 8, when the user wears the mask body 500, the space formed between the user's face and the inner surface of the mask body 500 forms the space S. (See FIGS. 3 and 4)

According to the present invention, a purified air supply means 200 for supplying purified air to the space S of the mask body 500 is provided.

The purified air supply means 200 has an air purification filter and a blowing part that draws air through the air purification filter from the outside and blows the air to the space S of the mask body 500, although not shown. Such a blowing part may be a fan or a blower.

The purified air supply means 200 supplies purified air to the space S of the mask body 500 through the supply channel 258.

The surface of the purified air supply means 200 is shown to have a plurality of air intake holes 208 formed therein through which air is drawn in.

According to the present invention, the purified air supply means 200 should generate pressure so that the purified air supplied to the space S of the mask body 500 can be forced to flow from the inlet 538 of the mask body 500 to the outlet 564 of the mask body 500.

That is, the pressure at which the purified air supply means 200 supplies the purified air to the space S of the mask body 500 should generate a pressure sufficient to force the purified air to flow from the inlet part 530 to the outlet part 560.

According to the present invention, the mask body 500 has the inlet part 530 having the inlet 538 through which the purified air supplied by the purified air supply means 200 flows into the space S, and also has the outlet part 560 having the outlet 564 through which the air flowing into the space S is discharged.

According to embodiments of the present invention, in some cases, the inlet part may have only the inlet so that the inlet may be directly the inlet part, and also, the outlet part may have only the outlet so that the outlet may be directly the outlet part.

In this embodiment, the inlet part 530 has an air distribution means for distributing air flowing in from the purified air supply means 200 and introducing it into the space S, and an inlet 538 is formed in the air distribution means.

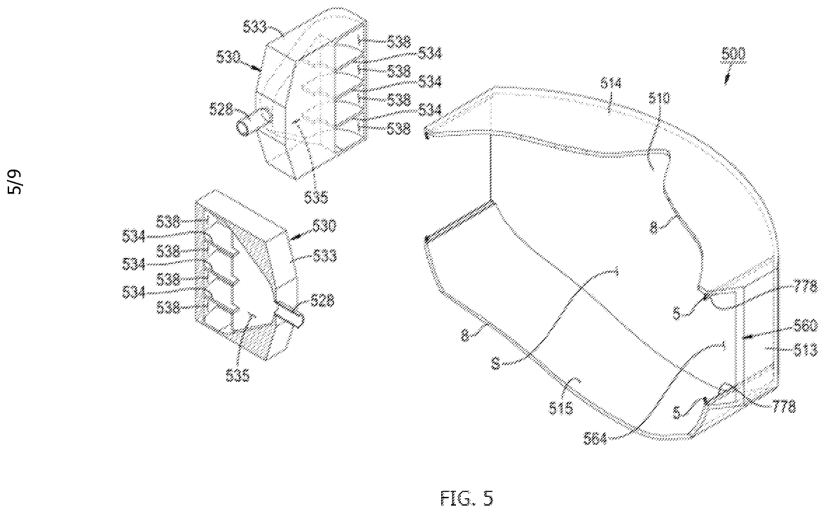

Referring to FIGS. 4 and 5, according to the present embodiment, the inlet part (530), which is an air distribution means, includes a body part 533, a connection channel 528 connected to the supply hose 258, a space part 535 communicating with the connection channel 528 inside the body part 533, and a plurality of the inlets 538 partitioned by a plurality of partitions 534 communicating with the space part 535.

In this embodiment, the outlet part 560 has the outlet 564 and guide rails 778, 778 installed respectively above and below the outlet 564.

Referring to FIG. 4, the outlet 564, in the case of this embodiment, is placed between the user's right cheek 83 and the right side 5134 of the mask body 500 when the mask body 500 is worn.

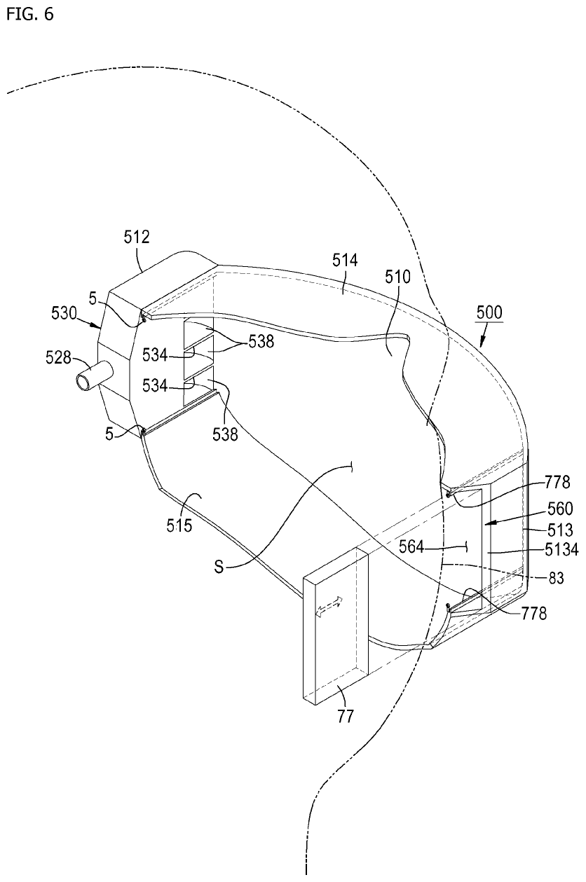

Also, as shown in FIG. 6, the air purification filter 77 is detachably installed with respect to the outlet 564 along the guide rails 778 and 778.

The air purification filter 77 is for preventing contaminants discharged from the user's respiration from being discharged to the outside. For example, a filter that filters viruses, such as the KF-94 standard, can be detachably installed.

According to the present invention, the space S of the mask body 500 preferably has a volume that can store an amount of air that the wearer breathes in one breath.

When the facial mask device 1000 provided according to the present invention is for adults, for example, it can have a volume of about 400 ml to 600 ml, and when it is for children, it can have a volume of about 250 ml to 400 ml.

If the volume of the space S of the mask body 500 is smaller than the volume that can store an amount of air that the wearer drinks in one breath, the forced air flow from the inlet 538 to the outlet 564 may be interfered by the wearer's respiration, and also, if the air flow rate is insufficient to cause respiration interference, or if a filter 77 is not installed in the outlet 564, contaminants from outside may be inhaled through the outlet 564 when breathing.

As described above, the air supplied by the air purifying means 200 forms a forced flow from the inlet 538 to the outlet 564 of the mask body 500, and according to the present invention, the wearer's respiratory system is located in the middle of this forced flow. According to the present invention, when the user wears the mask body 500 and the purified air supply means 200 operates, the purified air forcibly flowing from the inlet 538 to the outlet 564 is leaded into the user's respiratory system when the user inhales. In addition, when the user exhales, the exhaled breath is forcibly discharged through the outlet 564 along the forced flow.

That is, there is the forced flow of air from the inlet 538 to the outlet 564 of the mask body 500, and the user's respiratory system is located in the middle of the forced flow, so that when the user inhales, the forced flowing air is inhaled, and when the user exhales, the exhaled breath is discharged along the forced flow.

Accordingly, according to the present invention, comfortable respiration can be achieved. That is, it becomes easier to inhale and exhale with the help of the forced flow of air, and especially, carbon dioxide contained in the exhaled breath can be immediately discharged, making it possible to breathe more comfortably.

The purified air supply means 200 may be configured to adjust the pressure of the air supplied to the mask body 500 according to the user's exercise amount. In this case, it is possible to achieve an optimal forced flow pressure according to the respiratory state according to the user's exercise amount and the like.

This can be achieved by automatically adjusting the pressure of the air supplied to the mask body 500 through feedback control using a respiratory sensor, but it is also possible to present multiple blowing pressures and allow the user to select the blowing pressure themselves.

For example, the blowing pressure can be adjusted for each stage by setting 1st stage for resting breathing state, 2nd stage for walking, and 3rd stage for running.

According to the present invention, as shown in FIG. 4, it is desirable that the air supplied to the space S through the inlet 538 of the inflow part 530 flows in the direction T crossing the user's face.

The inlet 538 of the inlet part 530 forms a flow field in the direction crossing the user's face, and the air supplied to the space S through the inlet 538 flows along the direction crossing the user's face.

In this embodiment, the outlet 564 is interposed between the user's right cheek 83 of the mask body 500 which is opposite to the inlet 538 along the direction crossing the user's face and the right side 5134 of the mask body 500 when the mask body 500 is worn.

Although this is desirable, according to the present invention, it is enough for the outlet 564 of the outlet part 560 to be positioned at a place that crosses over the user's respiratory system along the direction that crosses the user's face when the user wears the mask body 500.

For example, as shown in FIG. 9, the outlet 564 may be formed on the upper surface 514 of the mask body 500 at a place that crosses over the user's respiratory system. However, the outlet 564 should be located at a distance that prevents external air from being sucked in by the suction force of the user's breathing when the user inhales.

According to the present invention, it is desirable that the outlet 564 of the outlet part 560 is formed vertically or at an acute angle to the vertical toward the rear direction of the mask body 500 with respect to the direction that crosses the face of the user wearing the mask body 500.

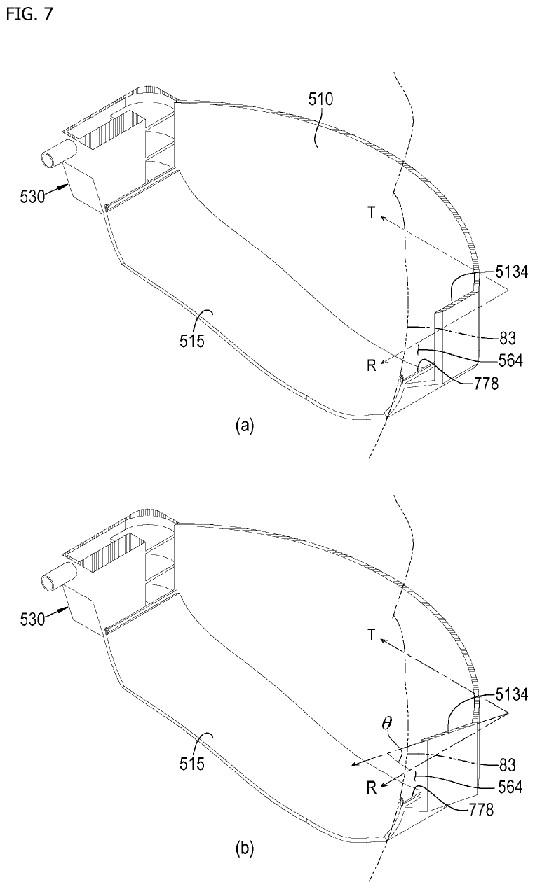

FIG. 7(a) shows that the outlet 564 is formed in a direction that is vertical R toward the rear direction of the mask body with respect to the direction T that crosses the face of the user wearing the mask body 500.

Also, FIG. 7(b) shows that the outlet 564 is formed at an acute angle θ to the vertical R toward the rear direction of the mask body with respect to the direction T that crosses the face of the user wearing the mask body 500.

This is to prevent wind from interfering with the flow of air discharged by the forced flow when the user wears the facial mask device 1000 according to the present invention and faces the wind.

For example, this is to prevent the wind from disturbing the flow of air that is discharged through the outlet 564 when the user wearing the facial mask device 1000 rides a bicycle or a motorcycle.

In this embodiment, the inlet 530 distributes the air that is introduced from the purified air supply means 200 and introduces it into the space S, and this is to suppress the formation of unnecessary flow recirculation in the air flow and to minimize the air staying at one point for a long time.

According to the present invention, as shown, the purified air supply means 200 is provided outside the mask body 500 and it is preferable to be used by being rested on the user's neck 93. (See FIG. 8)

In this embodiment, a wearing part 400 for the purified air supply means 200 is provided, which has an attachment part 410 that is combined with the purified air supply means 200 and has an opposite surface that is attached to the user's neck 93, and a hanger part 430 that extends from the attachment part 410 and can be hung on the neck.

Thus, for the following two reasons, the purified air supply means 200 should be located outside the mask body 500 and attached to the user's neck 93 when in use. First, the weight of the mask body worn on the face is reduced to make wearing comfortable.

Second, in the case of cooking, etc., oil vapor is generated, and such a pollutant source exists in front of the user. In this case, the purified air supply means 200, which purify the air and supply it to the mask body, is worn on the neck and located at the rear of the user, so that it takes in the air on the opposite side of the pollutant source to purify it, thereby reducing the intake of polluted air for purifying it.

Referral number 5 is a connecting pin that connects strings or bands 6 here to hang on the ears.

On the other hand, when the purified air supply means 200 is provided separately from the mask body 500, it becomes easier to make the mask body 500 transparent. If the purified air supply means 200 is installed with a fan or the like on the mask body as in the mask device of Korean Patent Publication No. 10-2020-0080110 and Korean Patent Registration No. 10-2256713, it would be difficult to make the mask body transparent. If the mask body is transparent, it can look natural and reduce the sense of rejection or alienation because the expression is visible when wearing it.

According to the present invention, the following unique effects can be achieved. First, the wearer can breathe more comfortably and discharge enough carbon dioxide with a simple structure.

This is because the mask body 500 has a forced air flow from the inlet 538 to the outlet 564, and the user's respiratory system is located in the middle of the forced air flow, so that when the user inhales, the forced air flow is inhaled, and when the user exhales, the exhaled breath is discharged along the forced air flow.

In other words, it becomes easier to inhale and exhale with the help of the forced air flow, and especially, the carbon dioxide contained in the exhaled breath can be immediately discharged, making it possible to breathe more comfortably.

Second, it is possible for a user wearing the facial mask device according to the present invention to have a conversation or make a phone call with worn by the user. This is because when the user's breathing is discharged, the outlet 564 is opened. By this, the user wearing the facial mask according to the present invention can have a conversation or make a phone call. Such utility may be reduced when an air purification filter 77 is installed on the outlet 564.

Third, the mask device reduces the weight of the mask body that is worn on the face, making it comfortable to wear, and also prevents the inflow of pollutants from the pollution source as much as possible when the pollution source mainly exists in front of the mask wearer, such as in the case of cooking.

This is because the purified air supply means 200 is separately provided for the mask body 500 and is put on the user's neck for use.

It can be understood that the purpose of the present invention has been achieved by this.

The present invention has been described with reference to the embodiments, but the scope of the patent right of the present invention is based on the following claims, and each claim will have its own effects.

1. A facial mask device comprising:
(a) a mask body worn on a user's face to cover the user's face including the user's respiratory system from one cheek of the user to the other cheek of the user; wherein a space is formed between the inside of the mask body and the user's face for storing air for the user's respiration,
(b) a purified air supply means for supplying purified air to the space of the mask body;
wherein,
(c1) an inlet through which the purified air by the purified air supply means is supplied into the space and an outlet through which the purified air supplied into the space through the inlet is discharged from the space to surroundings are formed in the mask body,
(c2) the outlet is positioned in the mask body at a place that crosses over the user's respiratory system face from the inlet along the transverse direction that crosses the user's face,
(c3) when the user wears the mask body and the purified air supply means operates, the purified air flows from the inlet to the outlet and the flow of the purified air forms a forced flow by pressure supplied by the purified air supply means into the space through the inlet, and
(c4) the user's respiratory system is positioned in the middle of the forced flow, so that when the user wears the mask body and the purified air supply means operates, the forced flowing air is inhaled when the user inhales and the exhaled breath is discharged when the user exhales along the forced flow.

2. The facial mask device as claimed in claim 1,
wherein the purified air supply means is provided separately from the mask body and connected to the mask body with a supply channel.

3. The facial mask device as claimed in claim 1, wherein the purified air supply means includes an air purification filter and a blowing part that draws air from outside through the air purification filter and blows the air to the space.

4. The facial mask device as claimed in claim 1, wherein the outlet is positioned between the user's cheek and a side of the mask body at opposite positions to the inlet with reference to the transverse direction that crosses the user's face when the user wears the mask body.

5. The facial mask device as claimed in claim 1, wherein the outlet is formed toward a rear direction of the mask body with respect to the transverse direction that crosses the face of the user wearing the mask body.

6. The facial mask device as claimed in claim 5, wherein the outlet is formed vertically toward the rear direction of the mask body with respect to the transverse direction that crosses the face of the user wearing the mask body or at an acute angle to the vertical toward the rear direction of the mask body and toward the user's cheek with respect to the transverse direction that crosses the face of the user wearing the mask body.

7. The facial mask device as claimed in claim 1, wherein the outlet is positioned on an upper surface part of the mask body.

8. The facial mask device as claimed in claim 1, wherein the inlet forms a flow field in the direction crossing the user's face, and the air supplied to the space through the inlet flows along the transverse direction crossing the user's face.

9. The facial mask device as claimed in claim 1, wherein an air purification filter is detachably installed with respect to the outlet.
